(19) United States
(12) Patent Application Publication
(10) Pub. No.: US 2026/0313412 A1
(43) Pub. Date: Oct. 8, 2026

(54) METHOD AND DEVICE FOR TRAINING AND INFERENCE BASED ON GENERATIVE NEURAL NETWORK IN WIRELESS COMMUNICATION SYSTEM

(71) Applicant: SAMSUNG ELECTRONICS CO., LTD., Suwon-si (KR)

(72) Inventors: Ikbeom LEE, Suwon-si (KR); Minsig HAN, Suwon-si (KR); Chaehun IM, Suwon-si (KR); Hayoung YANG, Suwon-si (KR)

(73) Assignee: SAMSUNG ELECTRONICS CO., LTD., Suwon-si (KR)

(21) Appl. No.: 19/637,393

(22) Filed: Apr. 2, 2026

Related U.S. Application Data
(63) Continuation of application No. PCT/KR2026/005139, filed on Apr. 2, 2026.

(30) Foreign Application Priority Data
Apr. 2, 2025 (KR) 10-2025-0043091
Jun. 12, 2025 (KR) 10-2025-0077155

(51) Int. Cl. H04W 24/08; G06N 3/0475; G06N 3/08

(52) U.S. Cl. CPC H04W 24/08; G06N 3/0475; G06N 3/08

(57) ABSTRACT

A method and a device for training and inference based on a generative neural network are provided. According to an embodiment, a receiver in a wireless communication system includes: communication circuitry; at least one processor communicatively connected to the communication circuitry; and memory storing at least one instruction that, when executed by the one or more processors individually or collectively, causes the receiver to: extract latent information from a reference signal (RS) of a first signal, received from a transmitter via the communication circuitry, estimate radio feature information related to the transmitter based on the latent information, and train a generative neural network for estimating radio feature information based on at least one dataset including the latent information and the estimated radio feature information.

### CROSS-REFERENCE TO RELATED APPLICATION(S)

This application is a continuation of International Application No. PCT/KR2026/005139 designating the United States, filed on Apr. 2, 2026, which is based on and claims priority to Korean Patent Application Nos. 10-2025-0043091, filed on Apr. 2, 2025, and 10-2025-0077155, filed on Jun. 12, 2025, in a Ministry of Intellectual Property, the disclosures of each of which are incorporated by reference herein in their entireties.

### BACKGROUND

### 1. Field

The disclosure relates to a wireless communication system, and more particularly, to a method and a device for training and inference based on a generative neural network.

### 2. Description of Related Art

In wireless communication systems, various signal processing technologies and artificial intelligence-based technologies are being introduced to enhance communication quality and efficient resource allocation between a user equipment (UE) and a base station.

In particular, with recent enhancements in deep learning performance and increases in computational resources, approaches using neural networks for communication system optimization are being actively researched. A generative neural network, unlike discriminative models, may learn complex distributions to generate new data and/or supplement missing values, enabling various applications such as prediction of communication environments or adaptive control.

However, existing wireless communication systems lack specific training and inference structures for effectively applying the generative neural networks to real-time communication environments, or have inadequate optimization structures considering limited resources (computational power, memory, etc.) of communication terminals or network devices. Further, there are limitations in designing neural network-based structures that may quickly respond to dynamic changes in communication environments.

Therefore, it is required to provide a structure capable of performing efficient training and inference based on a generative neural network in wireless communication systems.

The above-described information may be provided as related art for the purpose of helping understanding of the disclosure. The foregoing cannot be claimed as, or used to determine, the prior art related to the disclosure.

### SUMMARY

The disclosure provides a structure capable of performing efficient training and inference based on a generative neural network in wireless communication systems.

The objectives of the disclosure are not limited to those mentioned above, and other objectives not mentioned may be considered by those skilled in the art from various embodiments of the disclosure described below.

According to an embodiment of the disclosure, a receiver in a wireless communication system includes: communication circuitry; at least one processor communicatively connected to the communication circuitry; and memory storing at least one instruction that, when executed by the one or more processors individually or collectively, causes the receiver to: extract latent information from a reference signal (RS) of a first signal received from a transmitter via the communication circuitry; estimate radio feature information related to the transmitter based on the latent information; and train a generative neural network for estimating radio feature information based on at least one dataset including the latent information and the estimated radio feature information.

According to an embodiment of the disclosure, a non-transitory computer-readable storage medium storing at least one instruction that, when executed by at least a portion of at least one processor of a receiver, causes the receiver to perform: extracting latent information from a reference signal (RS) of a first signal received from a transmitter; estimating radio feature information related to the transmitter based on the latent information; and training a generative neural network for estimating radio feature information based on at least one dataset including the latent information and the estimated radio feature information.

According to an embodiment of the disclosure, a method performed by a receiver in a wireless communication system includes: extracting latent information from a reference signal (RS) of a first signal received from a transmitter; estimating radio feature information related to the transmitter based on the latent information; and training a generative neural network for estimating radio feature information based on at least one dataset including the latent information and the estimated radio feature information.

### BRIEF DESCRIPTION OF DRAWINGS

The above and other aspects, features, and advantages of certain example embodiments of the disclosure will be more apparent from the following description taken in conjunction with the accompanying drawings.

FIG. 1 is a block diagram illustrating a configuration of an electronic device that may be commonly applied to a base station or a terminal in a wireless communication system.

FIG. 2 is a block diagram illustrating a generative artificial intelligence (AI) system according to one or more embodiments of the disclosure.

FIG. 3 is a block diagram illustrating an AI Framework according to an embodiment of the disclosure.

FIG. 4 illustrates an example of a wireless communication system according to one or more embodiments of the disclosure.

FIGS. 5A and 5B illustrate an example of a framework for a cellular generative neural network (CGN) according to an embodiment of the disclosure.

FIG. 6 illustrates an example of a structure of a data collection unit in a framework of a cellular generative neural network (CGN) according to an embodiment of the disclosure.

FIG. 7 illustrates an example of a structure of an on-site training unit in a framework of a cellular generative neural network (CGN) according to an embodiment of the disclosure.

FIG. 8 illustrates an example of a training operation in an on-site training unit in a framework of a cellular generative neural network (CGN) according to an embodiment of the disclosure.

FIG. 9 is a diagram illustrating a system structure for training and inference of a cellular generative neural network (CGN) according to an embodiment of the disclosure.

FIG. 10 is a flowchart illustrating an operation of an electronic device according to an embodiment of the disclosure.

FIG. 11 illustrates results of estimating radio feature information (Doppler Shift) using a generative neural network according to an embodiment of the disclosure.

These drawings are included as reference examples to aid understanding of the disclosure and are not limited to specific embodiments of the invention. The specific content illustrated in the drawings includes supplementary description of the overall technical background and context of the disclosure, and even when not directly specified in the claims, may provide beneficial technical information for the disclosure.

### DETAILED DESCRIPTION

Hereinafter, example embodiments of the disclosure are described in detail with reference to the accompanying drawings.

In describing the embodiments, the description of technologies that are known in the art and are not directly related to the disclosure is omitted. This is for further clarifying the gist of the disclosure without making it unclear.

For the same reason, some components in the accompanying drawings are emphasized, omitted, or schematically illustrated. The size of each element does not necessarily reflect the real size of the element. The same reference numbers are given to the same or corresponding components in each drawing.

The advantages and features of the disclosure and methods of achieving them will become apparent by referring to the embodiments described in detail below together with the accompanying drawings. However, the disclosure is not limited to the embodiments disclosed below but may be implemented in various different forms, and these embodiments are provided only to make the disclosure complete and to fully inform those skilled in the art of the scope of the invention, and the disclosure is defined only by the scope of the claims. The same reference numeral denotes the same element throughout the specification.

It should be appreciated that the blocks in each flowchart and combinations of the flowcharts may be performed by computer program instructions. These computer program instructions may be mounted on a processor of a general-purpose computer, special-purpose computer, or other programmable data processing equipment, such that the instructions executed through the processor of the computer or other programmable data processing equipment may perform the functions described in the flow diagram block(s). These computer program instructions may be stored in computer-usable or computer-readable memory that may direct a computer or other programmable data processing equipment to function in a particular manner, such that the instructions stored in the computer-usable or computer-readable memory may perform the functions described in the flow diagram block(s). The computer program instructions may be loaded onto a computer or other programmable data processing equipment, such that a series of operational steps are performed on the computer or other programmable data processing equipment to create a computer-executed process, and the instructions that execute the computer or other programmable data processing equipment may provide steps for executing the functions described in the flow diagram block(s).

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

Hereinafter, the base station may be an entity allocating resource to a terminal and may be at least one of gNode B (gNB), eNode B (eNB), Node B, base station (BS), wireless access unit, base station controller, or node over network.

The terminal may include UE (user equipment), MS (mobile station), cellular phone, smartphone, computer, or multimedia system capable of performing communication functions.

In the disclosure, downlink (DL) refers to a wireless transmission path of signals transmitted from the base station to the UE, and uplink (UL) refers to a wireless transmission path of signals transmitted from the UE to the base station. Although long term evolution (LTE), LTE advanced (LTE-A), or 5th-generation (5G) systems may be described below as an example, the embodiments may be applied to other communication systems having a similar technical background or channel pattern. For example, this may include 5th-generation (5G) mobile communication technology (new radio, NR) or 6th-generation (6G) mobile communication technology developed after LTE-A, and the following 5G may be a concept including existing LTE, LTE-A, and similar other services. Further, the embodiments may be modified in such a range as not to significantly depart from the scope of the disclosure under the determination by one of ordinary skill in the art and such modifications may be applicable to other communication systems.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

Hereinafter, various embodiments are described in detail with reference to the accompanying drawings, noting that the same components in the accompanying drawings are indicated with the same reference numerals as much as possible. Further, the drawings of the disclosure attached below are provided to help understand the disclosure, and it should be noted that the disclosure is not limited to the forms or arrangements illustrated in the drawings of the disclosure. Further, detailed descriptions of well-known functions and configurations that may obscure the gist of the disclosure is omitted. In the following description, only the portions necessary to understand the operation according to various embodiments of the disclosure are described, and descriptions of other portions are omitted so as not to distract from the gist of the disclosure.

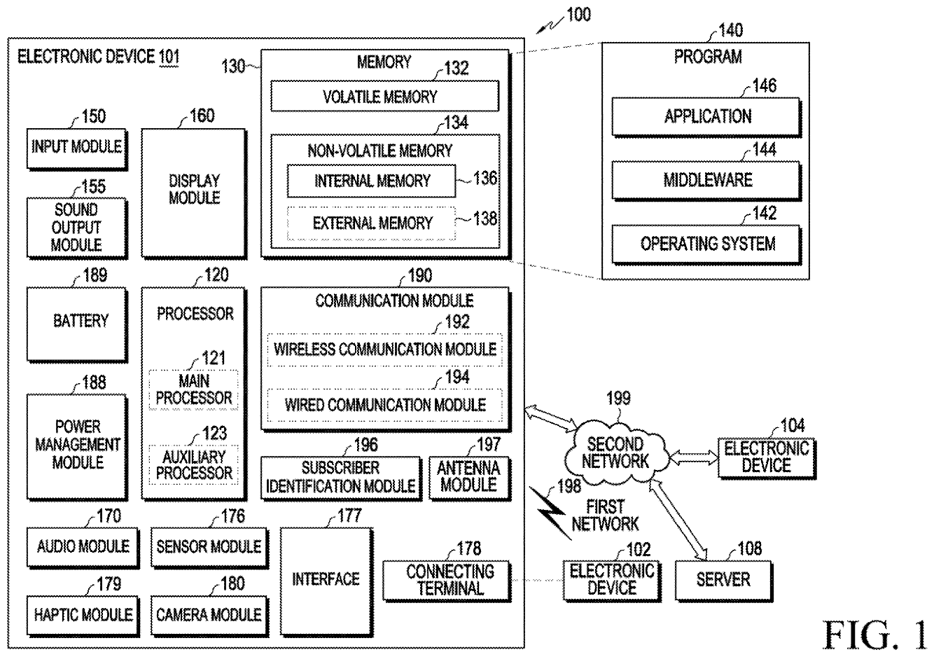

FIG. 1 is a block diagram illustrating a configuration of an electronic device that may be commonly applied to a base station or terminal in a wireless communication system.

FIG. 1 is a block diagram illustrating an electronic device 101 in a network environment 100, according to various embodiments.

The electronic device 101 described in the disclosure may be at least one of a terminal (e.g., user equipment, UE) or a base station (BS), which may include similar hardware components. In other words, the configuration illustrated in FIG. 1 may be understood as representing a general electronic device structure commonly applicable to a terminal and/or a base station.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108.

According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

For example, when the electronic device 101 is a base station device, user interface-related configurations such as the display module 160, the input module 150, and/or the camera module 180 may be omitted, and only configurations for network control and data processing such as the communication module (or communication circuitry) 190, the processor 120, and the memory 130 may be included.

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), a secure processing unit (SPU), an image signal processor, a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network (DQN) or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146. One or more related applications may form a service configured to handle a series of user requests.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance in high-frequency bands, e.g., technologies such as beamforming, multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101.

The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

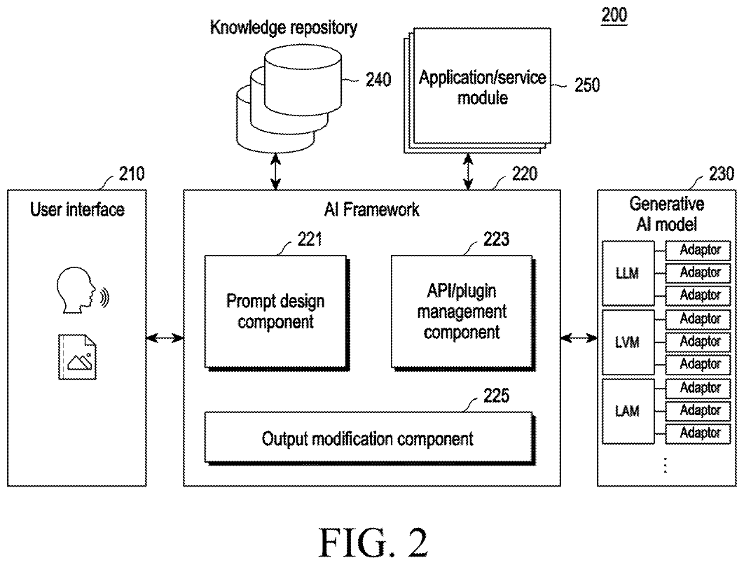

FIG. 2 illustrates a generative artificial intelligence (AI) system 200 according to an embodiment.

Referring to FIG. 2, the generative AI system 200 may include a User Interface 210, an AI Framework 220, a Generative AI Model 230, a Knowledge Repository 240, and an Application/Service Module 250. These components may be operated on one or more devices among the electronic device 101, the external electronic device 102 or 104, or the server 108. For example, the electronic device 101 may be at least one of a terminal or a base station, and the components illustrated in FIG. 2 may be operated on at least one of the terminal or the base station. For example, the User Interface 210 and the AI Framework 220 may be operated on the electronic device 101, while the Knowledge Repository 240 and the Generative AI Model 230 may be operated on the server 108.

According to an embodiment, the User Interface 210 may receive a user input (e.g., user query). The user input may be received in the form of text, image, voice (e.g., natural language), video, menu selection, or a combination thereof. The User Interface 210 may include, in addition to or instead of the user's input, various context information (e.g., running applications or user's location) related to the generative artificial intelligence system 200 at the time when the user input is received. The User Interface 210 may provide the user input and/or the context information to the AI Framework 220, and provide results of processing thereof to the user, e.g., through the AI Framework 220. According to an embodiment, in addition to the user input, the electronic device 101 may provide context information obtained using information included on a screen to the AI Framework 220. The results may be provided in the form of text, image, voice, video, action requested by the user (e.g., executing a designated function or app), or a combination thereof.

The AI Framework 220 may include a Prompt Design Module (or Prompt Design Component) 221, an application programming interface (API)/Plug-in Management Module (or API/Plug-in Management Component) 223, and an Output Modification Module (or Output Modification Component) 225, as illustrated in FIG. 2. According to an embodiment, the AI Framework 220 may identify (e.g., predict or estimate) user intent based at least in part on the user input and/or context information received from the User Interface 210, and control each related module (e.g., 221, 223, or 225) and coordinate collaboration between two or more related modules to perform functions or operations corresponding to the identified user intent.

According to an embodiment, the Prompt Design Module 221 may generate a prompt to be input to the Generative AI Model 230 based at least in part on the user input and/or context information received from the User Interface 210. For example, the Prompt Design Module 221 may generate a prompt using at least one of a user preference, a prompt library, or a prompt example stored in the Knowledge Repository 240 based at least in part on the user input and/or context information.

According to an embodiment, when there is a request for additional information related to the user input, the API/Plug-in Management Module 223 may communicate with various resources providing additional information (e.g., Knowledge Repository 240), e.g., through an API. In one or more examples, when an action (e.g., function, app, or service) is designated to be performed based on the user input, the API/Plug-in Management Module 223 may request the Application/Service Module 250 to perform the designated action through the corresponding API. The API/Plug-in Management Module 223 may provide information obtained from the Knowledge Repository 240, the Application/Service Module 250, and/or another external resource to the Prompt Design Module 221. The obtained information may be used by the Prompt Design Module 221 to generate a prompt along with the user input or may be provided to the Generative AI Model 230.

According to an embodiment, the Output Modification Module 225 may fine-tune results obtained through the Generative AI Model 230 as at least part of a response to the user input (e.g., user query). For example, the Output Modification Module 225 may determine whether the content of the response obtained through the Generative AI Model 230 is appropriate as a response to the request of the user's input. For example, the Output Modification Module 225 may determine a degree of relevance between the response obtained through the Generative AI Model 230 and the user input, the degree of bias (e.g., political or social bias), or the degree of harmfulness (e.g., sexual or profane). In one or more examples, the Output Modification Module 225 may request additional AI processing to be performed on the obtained response, or provide a hint to the user to avoid an unwanted output. For example, an additional prompt may be generated through the Prompt Design Module 221 to obtain a response again through the Generative AI Model 230.

According to an embodiment, the Generative AI Model 230 may include at least part of an artificial intelligence neural network and may include a model configured to generate an image or a model configured to generate language. The image generation model may include, e.g., a generative adversarial network (GAN), a variational auto encoder (VAE), and/or a Diffusion-based model using a VAE and a Transformer. The language generation model may include, e.g., a large language model (LLM), a large multimodal model (LMM), a large vision model (LVM), and/or a large action model (LAM). The LAM may automatically generate actions for an environment (e.g., robot, car, the electronic device 101, or program 140). Further, for at least one AI model (e.g., LLM), low-rank adaptation (LoRA) adaptors fine-tuned for specific tasks or specific circumstances may be provided.

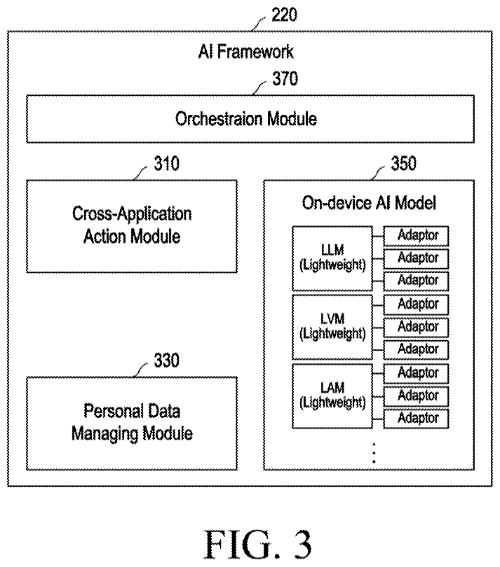

FIG. 3 illustrates the AI Framework 220 with on-device AI processing capability according to an embodiment.

The AI Framework 220 may generate and learn responses to the user input using resources within a device (e.g., the electronic device 101) instead of or in addition to sending the user input received through the User Interface 210 operated on the same device to the Generative AI Model 230 operated on an external device (e.g., server 108). Referring to FIG. 3, the AI Framework 220 may include a Cross-Application Action Module 310, a Personal Data Managing Module 330, an On-device AI Model 350, and an Orchestration Module 370.

According to an embodiment, the Cross-Application Action Module 310 may determine one or more additional applications needed for the operation of an executed application (e.g., assistant app) and connect or suggest operations between the app and at least one additional application, or between multiple additional applications. For example, the Cross-Application Actions Module 310 may execute one or more additional applications to be used to respond to a user request through the assistant app sequentially or, at least partially, simultaneously. Further, the Cross-Application Action Module 310 may communicate with the corresponding additional applications such that the execution result (e.g., content) of one additional application may be shared with another additional application.

According to an embodiment, the Personal Data Managing Module 330 may provide personal information (e.g., schedule, contacts, or message information) about the user of the device (e.g., the electronic device 101) where the application (e.g., assistant app) or the additional application is executed, or related other individuals (e.g., family or friends) to other modules of the AI Framework 220 and/or related modules operated on other devices (e.g., Generative AI Model 230).

According to an embodiment, the On-device AI Model 350 may include at least one model among one or more AI models (e.g., GAN, VAE, LLM, LMM, LVM, or LAM) operated on an external device (e.g., server 108) or a corresponding lightweight AI model. Further, for example, a LoRA adaptor may be provided for the at least one model or its lightweight model.

According to an embodiment, the Orchestration Module 370 may select one or more AI models to be used to obtain a response to a user input (e.g., user query). For example, the Orchestration Module 370 may select one or more AI models from the On-Device AI Model 350, an AI model operated on an external device (e.g., server 108) (e.g., Generative AI Model 230), and/or a third AI model (not illustrated) operated on another external device. When multiple AI models are selected, the Orchestration Module 370 may communicate with the corresponding models or devices such that the operations between the selected AI models and the processing of their outputs may be coordinated between the related models or related devices.

According to an embodiment, two or more modules of the generative AI system 200 (e.g., Cross-Application Action Module 310 and Orchestration Module 370) may be implemented as one module to maintain the same functionality. Various modifications are possible.

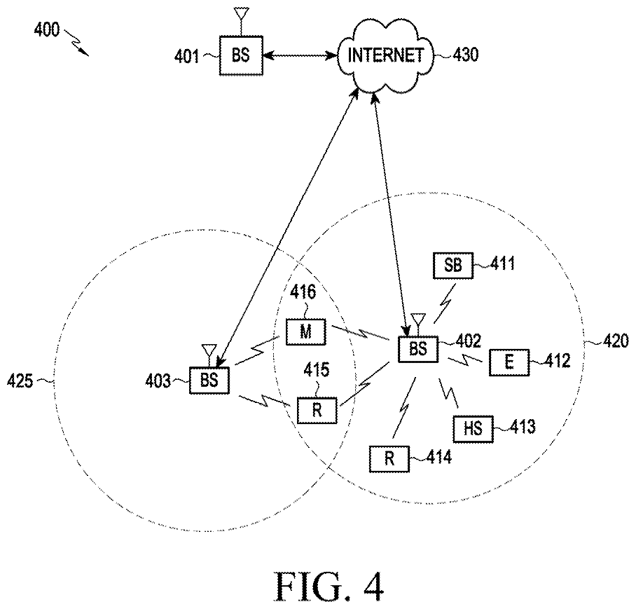

FIG. 4 illustrates an example of a wireless communication system 400 according to one or more embodiments of the disclosure.

The embodiment of the wireless communication system 400 (or wireless network) illustrated in FIG. 4 is for illustration only. Other embodiments of the wireless communication system 400 may be used without departing from the scope of the disclosure.

As illustrated in FIG. 4, the wireless communication system 400 includes a base station 401, a base station 402, and a base station 403. The base station 401 may communicate with the base station 402 and the base station 403. Further, the base station 401 may communicate with at least one network 430 such as the Internet, a dedicated Internet Protocol (IP) network, or other data networks.

The base station 402 may provide network 430 wireless broadband access to a plurality of first terminals within its coverage area 420. The plurality of first terminals may include a terminal 411 located in a small business (SB); a terminal 412 located in an enterprise (E); a terminal 413 at a Wi-Fi hotspot (HS); a terminal 414 in a first residence (R); a terminal 415 in a second residence; and a terminal 416 that may be a mobile device (M) such as a mobile phone, wireless laptop, or wireless PDA. The base station 403 may provide network 430 wireless broadband access to a plurality of second terminals within its coverage area 425.

The plurality of second terminals may include the terminal 415 and the terminal 416. In some embodiments, one or more base stations 401-403 may communicate with each other and with the terminals 411-416 using 5G, LTE, LTE-A, WiMAX, Wi-Fi®, or other wireless communication technologies.

Depending on the network type, the term “base station (BS)” may refer to any component (or collection of components) configured to provide wireless access to a network, such as a transmit point (TP), transmit-receive point (TRP), enhanced base station (eNodeB, eNB), 5G base station (gNB), macrocell, femtocell, Wi-Fi access point (AP), or other wireless-enabled devices. A base station may provide wireless access according to one or more wireless communication protocols, e.g., 5G 3GPP NR (new radio interface/access), LTE (long term evolution), LTE-A (LTE advanced), HSPA (high speed packet access), Wi-Fi 802.11a/b/g/n/ac, etc. The terms “base station” and “transmit-receive point” may be used interchangeably herein to refer to network infrastructure components that provide wireless access to remote terminals. Further, according to the network type, the term “user equipment (UE)” may refer to components such as a mobile station, subscriber station, remote terminal, wireless terminal, receive point, or user device. For convenience, the term “terminal” may be used herein to refer to remote wireless devices that wirelessly connect to a base station, regardless of whether the terminal is generally considered a mobile device (such as a mobile phone or smartphone) or a stationary device (such as a desktop computer or vending machine).

In FIG. 4, dashed lines are used to show an approximate extent of the coverage areas 420, 425, which are illustrated approximately circular for illustration and explanation purposes only. It should be clearly understood that base station-related coverage areas such as the coverage areas 420, 425 may have other shapes, including irregular shapes, according to the configuration of the base stations and changes in a wireless environment related to natural and/or artificial obstacles.

As described below in greater detail, one or more of the terminals 411-416 may include circuitry, programming, or a combination thereof for receiving configuration information regarding resource allocation for uplink transmission, applying uplink precoding to G antenna port groups based on uplink precoding information, and performing uplink transmission on allocated resources according to the configuration information. This configuration information may include allocated resources for uplink transmission and uplink precoding information for G antenna port groups for uplink transmission on the allocated resources, and the uplink precoding information may include spatial-domain (SD) basis vectors, frequency domain (FD) basis vectors, coefficients for SD and FD basis vector pairs, and two elements for the coefficients across all of the G antenna port groups.

One or more of the base stations 401-403 may include circuitry, programming, or a combination thereof for generating configuration information regarding resource allocation for uplink transmission, transmitting the configuration information, and receiving uplink transmission on allocated resources according to the configuration information based on uplink precoding applied to G antenna port groups and based on the uplink precoding information. This configuration information may include allocated resources for uplink transmission and uplink precoding information for G antenna port groups for uplink transmission on the allocated resources, and the uplink precoding information may include spatial-domain (SD) basis vectors, frequency domain (FD) basis vectors, coefficients for SD and FD basis vector pairs, and two elements for the coefficients across all of the G antenna port groups.

Although FIG. 4 illustrates one example of a wireless network, various changes may be made to FIG. 4. For example, the wireless network may include any number of base stations and any number of terminals in an appropriate arrangement. Further, the base station 401 may directly communicate with any number of terminals and provide those terminals with wireless broadband access to the network 430. Similarly, each base station 402-403 may directly communicate with the network 430 and provide terminals with direct wireless broadband access to the network 430. Further, the base stations 401, 402, and/or 403 may provide access to other or additional external networks such as external telephone networks or other types of data networks.

In a performance of artificial neural networks used in wireless communication systems, particularly mobile communication systems, securing a large amount of training data is an important factor. Methods of training artificial neural networks may include offline training and online training.

Offline training refers to a method of training a neural network using data obtained from a network in advance or data obtained through a Link Level Simulator. In this case, it may not be predetermined whether sufficient training has been performed based on actual field data.

On the other hand, online training is a method of training with actual data obtained from each cell by signals transmitted and received between each terminal and base station in a mobile communication system, and using online training may design a neural network optimized for the wireless environment of that cell. When obtaining data in an actual field environment, how to secure True Labels may be an important issue.

Estimating and predicting a radio feature in wireless communication systems (e.g., mobile communication systems) is an important factor in reception performance. For example, estimating a channel between a base station and a terminal is one of the important factors in the signal reception performance between the base station and terminal.

The radio feature in wireless communication systems (e.g., mobile communication systems) may include, for example but not limited to, a channel feature, an interference feature, and a cell feature.

The disclosure provides a training method using a neural network to estimate a radio feature related to a signal transmission/reception procedure. The disclosure provides a neural network training method at a base station or a terminal, particularly an online neural network training and inference method in a cell environment where a neural network is to be applied.

For example, major channel features representing characteristics of a channel between a base station and a terminal may include elements such as power delay profile (PDP) and Doppler spread.

The disclosure provides estimation and prediction of the radio feature based on a location feature (e.g., surrounding environment of a cell). The channel feature included in the radio feature may include Doppler Spread, Doppler Shift, Delay Spread of Fading Channel, line of sight (LOS), non-line of sight (NLOS), etc.

The interference feature may include Noise Interference Power estimated per resource block (RB) or Noise Interference Power estimated per receiving antenna, various signal-to-noise ratios (SNR), etc. The cell feature may be represented as beamforming information. The beamforming information may include analog/digital beam index estimation, prediction, and codebook generation.

The generative neural network training and inference method according to the disclosure may be applied to both base stations and terminals (UE), and hereinafter, for convenience, it is described as applied to a base station, but the disclosure is not limited thereto.

The generative neural network training and inference method according to the disclosure may be applied to uplink where the base station becomes the receiver when applied to the base station, and may be applied to downlink where the UE becomes the receiver when applied to the terminal. For example, when applied to a base station, the method may be used to estimate a channel feature, an interference feature, and/or a beamforming feature of a cell and, when applied to a terminal, the method may be applied to estimate a channel feature, an interference feature, and/or a beamforming feature as the radio feature of the terminal.

Further, the base station or terminal may transmit the radio feature information estimated by the method according to the disclosure to the terminal or base station. Various transmission methods are available, and in an embodiment, a method of transmitting neural network-related parameters including neural network weights, and/or transmitting pre-defined neural network indexes may be used.

Hereinafter, a method of modeling a received signal (e.g., signal received via the communication module 190 in FIG. 1) for a generative neural network is described.

A signal received through an antenna of the base station corresponding to an ith antenna and an Ith reference signal (RS) symbol, represented as a frequency domain received signal after Fast Fourier Transform (FFT), is represented as follows in Equation 1.

$${r}_{l , k}^{i} = {H}_{l , k}^{i} {x}_{l , k}^{i} + {n}_{l , k}^{i} \qquad [ Equation 1 ]$$

In Equation 1, Hⁱ_{l,k} denotes a channel matrix of a kth subcarrier, and represents a Pilot sequence of the kth subcarrier. nⁱ_{l,k} is additive white Gaussian noise (AWGN) of the kth subcarrier. Here, k=0, 1, . . . , N_{SC-1}, N_{SC}=Allocated_RB*6 is a number of Pilot tones allocated to the Reference Symbol.

After decorrelating the Pilot sequence xᵢ^{l,k} from the received signal rᵢ^{l,k}, Equation 2 is obtained.

$${Y}_{l , k}^{i} = {r}_{l , k}^{i} \cdot {x}_{l , k}^{i *} = {H}_{l , k}^{i} + {n}_{l , k}^{i} {x}_{l , k}^{i *} \qquad [ Equation 2 ]$$

The De-Correlated RS for N_{SC} tones at the ith antenna and lth RS symbol represented as a vector is as shown in Equation 3 below.

$$\overline{{Y}_{l}^{ι}} = [ {Y}_{l , 0}^{i} , {Y}_{l , 1}^{i} , {Y}_{l , 2}^{i} , … , {Y}_{l , {N}_{SC - 1}}^{i} ] \qquad [ Equation 3 ]$$

The De-Correlated RS for all antennas represented as a Matrix is as shown in Equation 4. Here, Nᵣₓ is a number of receiving antennas.

$${Y}_{l} = [ \begin{matrix}\overline{{Y}_{l}^{0}} \\ \overline{{Y}_{l}^{1}} \\ ⋮ \\ \overline{{Y}_{l}^{{N}_{rx} - 1}}\end{matrix} ] \qquad [ Equation 4 ]$$

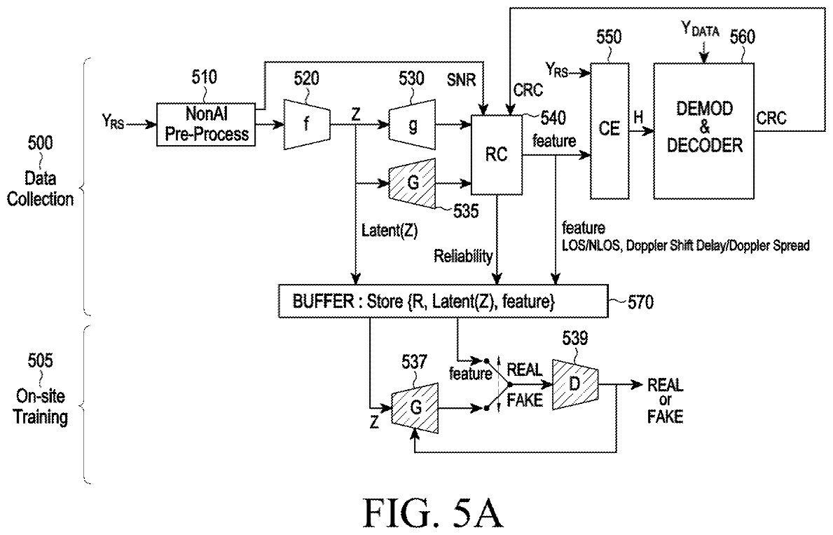

FIGS. 5A and 5B illustrate an example of a framework structure of a cellular generative neural network (CGN) according to an embodiment of the disclosure.

FIG. 5A illustrates a framework structure for training of a cellular generative neural network (CGN), and FIG. 5B illustrates a framework structure for inference using a cellular generative neural network (CGN).

Although FIGS. 5A and 5B are illustrated separately for convenience, inference and training using a generative neural network may be performed in parallel in an on-site training environment, and configurations indicated with the same reference numbers in FIGS. 5A and 5B may represent substantially the same configurations.

Referring to FIG. 5A, the framework for training of a cellular generative neural network (CGN) may include a data collection unit 500 and an on-site training unit 505.

The data collection unit 500 may preprocess and collect data to be used for generative neural network training. In an embodiment, the data collection unit 500 may include at least one of a pre-process unit 510, a latent extraction unit (f) 520, feature estimation units (g, G) 530, 535, and a reliability check unit (RC) 540. Further, the data collection unit 500 may include a channel estimator 550 and a demodulator and decoder 560.

Referring to FIG. 5A, the latent extraction unit (f) 520 may extract latent information (Z) from the reference signal (RS) that has passed through the pre-process unit 510, and the feature estimation units (g, G) 530, 535 may extract a radio feature based on the latent information (Z). The radio feature may include, e.g., a channel feature such as LOS/NLOS, Doppler Shift Delay, and/or Doppler Spread. For example, the radio feature may include, in addition to a channel feature, an interference feature and/or a beam feature related to inference to operate a wireless communication system.

Thereafter, the reliability check unit (RC) 540 may identify reliability of the extracted feature(s) and transmit radio feature information satisfying a specific reliability condition to the channel estimator 550. The channel estimator 550 may estimate a channel for the RS of the received signal based on the received radio feature information. The demodulator and decoder 560 may output a cyclic redundancy check (CRC) value based on the estimated channel. In an embodiment, the output CRC value may be input to the reliability check unit (RC) 540 and used for reliability checking along with an SNR.

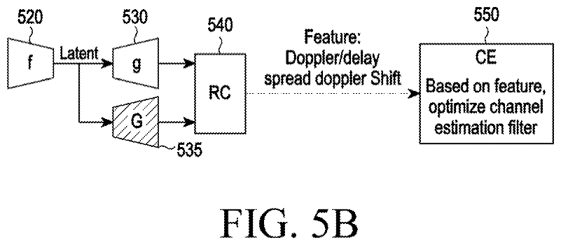

An example of a configuration and an operation of the data collection unit 500 illustrated in FIG. 5A will be described later with reference to FIG. 6.

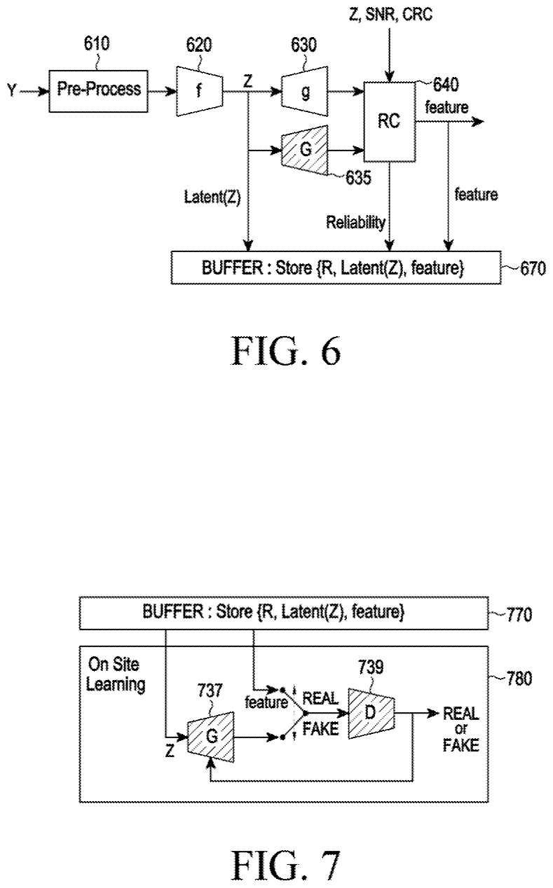

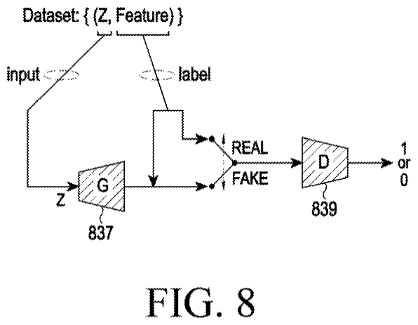

In FIG. 5A, the on-site training unit 505 may perform a training process to update parameters of a generative neural network (G) 537 and a discriminator neural network (D) 539 using data collected in a buffer 570. An example of a configuration and a training operation flow of the on-site training unit 505 will be described later with reference to FIGS. 7 and 8.

FIG. 5B illustrates that the framework for inference of a channel feature using a cellular generative neural network (CGN) may include a latent extraction unit (f) 520, feature estimation units (g, G) 530, 535, a reliability check unit (RC) 540, and a channel estimator (CE) 550.

In an embodiment, the latent extraction unit 520 and the first feature estimation unit 530 may correspond to analytic neural networks (f, g), and the second feature estimation unit 535 may correspond to a generative neural network (G). The generative neural network (G) of the second feature estimation unit 535 may be trained with the framework for training of a cellular generative neural network (CGN) illustrated in FIG. 5A.

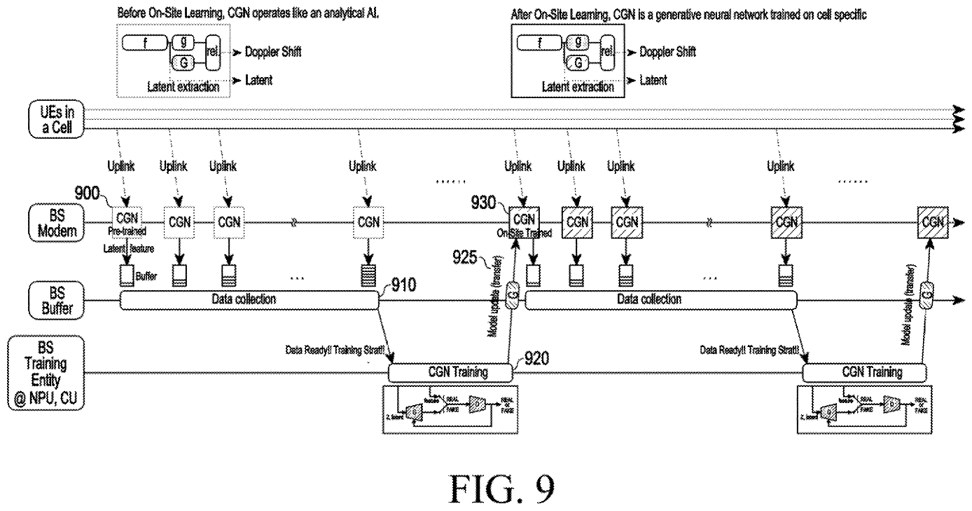

In FIG. 5B, the latent extraction unit (f) 520, feature estimation units (g, G) 530, 535, and reliability check unit (RC) 540 may infer radio feature information and output radio feature information, and the channel estimator 550 may optimize a channel estimation filter based on the radio feature information. An example of an inference operation will be described later with reference to FIG. 9.

FIG. 6 illustrates an example of a structure of a data collection unit in a framework of a cellular generative neural network according to an embodiment of the disclosure.

Referring to FIG. 6, configurations related to data collection in the framework of a cellular generative neural network may include at least one of a pre-process unit 610, a latent extraction unit (f) 620, feature estimation units (g, G) 630, 635, a reliability check unit (RC) 640, and a buffer 670. In on-site training, the data collection unit may include the input pre-processing unit 610 configured to preprocess a received signal Y, a latent extraction unit 620 configured to extract latent information (Z) from its output result, a first radio feature estimation unit 630 and a second radio feature estimation unit 635 configured to estimate a radio feature from the extracted latent information (Z), and a reliability check unit (RC) 640 configured to determine reliability of the estimated radio feature.

The buffer 670 for on-site training may store at least one of latent information, radio feature information, and/or reliability information.

As shown in Equation 4, the received signal has large dimensions with antennas, subcarriers, and symbols. Storing the received signal in a buffer requires a very large memory buffer, and the required memory buffer size may be decreased by extracting and storing latent information used for estimation a feature representing a cell feature.

To compress and/or extract relevant information while minimizing information loss of existing data as in Equation 4, the input pre-processing unit 610 and the latent extraction unit 620 may be provided, and the latent extraction unit 620 may correspond to an analytic neural network (f).

First, the input pre-processing unit 610 may convert the received signal Y into a form including the feature to be estimated using one or more formulas without using a neural network. In this case, to reduce information loss, the input pre-processing unit 610 may be omitted and the received signal Y may directly enter the analytic neural network (f).

The latent extraction unit 620 may extract latent variables for radio feature estimation from the received signal Y or the output of the input pre-processing unit 610. In an embodiment, the latent extraction unit 620 may correspond to the analytic neural network (f). In an embodiment, the latent extraction unit 620 may store the extracted latent information in the buffer 670 for data collection to be used for on-site AI training. In an embodiment, the latent extraction unit 620 may extract latent information using a signal processing method without using a neural network.

The first radio feature estimation unit 630 may estimate radio feature information from the latent information extracted by the latent extraction unit 620. In an embodiment, the first radio feature estimation unit 630 may correspond to an analytic neural network (g). In an embodiment, the first radio feature estimation unit 630 may store the estimated radio feature information in the buffer 670 for data collection to be used for on-site AI training. In this case, the extracted latent information and radio feature information may be stored as pairs. In an embodiment, the first radio feature estimation unit 630 may estimate radio feature information using a signal processing method without using a neural network.

The second radio feature estimation unit 635 may estimate radio feature information from the latent information extracted by the latent extraction unit (f) 620. In an embodiment, the second radio feature estimation unit 635 may correspond to a generative neural network (G). In an embodiment, the second radio feature estimation unit 635 may store the estimated radio feature information in the buffer 670 for data collection to be used for on-site AI training. In this case, the extracted latent information and radio feature information may be stored as pairs.

The reliability check unit (RC) 640 may store a signal-to-noise ratio (SNR) estimated from the received signal Y and a cyclic redundancy check (CRC) output from the decoder as reliability (R) information in the buffer 670 for data collection to be used for on-site AI training to evaluate the accuracy of radio feature estimation. In this case, the SNR and the CRC may correspond to examples of stored reliability (R) information, and various non-AI and AI-based reliability estimation results representing the reliability of stored {latent information, radio feature information} pairs may be stored.

In an embodiment, the reliability check unit (RC) 640 may receive outputs of the analytic neural network (g) of the first radio feature estimation unit 630 and the generative neural network (G) of the second radio feature estimation unit 635 according to the reliability of the estimated radio features to determine a final output.

Referring to FIG. 6, data stored in the buffer 670 for data collection may undergo data pre-processing to configure training data for on-site training.

When the information stored in the buffer 670 is {reliability (R) information, latent information, feature information}, training data may be configured by selecting some {latent information, feature information} from all stored data based on the reliability (R) information. For example, training data may be configured by selecting {latent information, feature information} only when the reliability (R) information satisfies a predefined condition for reliability (R) information.

In an embodiment, a training data reconstruction operation may be performed that connects feature information of different reliability (R) instead of its own feature to stored data {latent information, feature information} corresponding to specific reliability (R) information. For example, for stored data {latent information, feature information} for a received signal that has not passed CRC, a training data reconstruction operation may be performed that maps feature information of different reliability (R) instead of its own feature.

For example, when an SNR is used as reliability (R) information, stored data corresponding to high, mid, and low field strength according to an SNR in the data collection buffer 670 may be stored separately as {R^{high}, Latent^{high}, Feature^{high}}, {R^{mid}, Latent^{mid}, Feature^{mid}}, and {R^{low}, Latent^{low}, Feature^{low}}. Classifying an SNR into three levels including high, mid, and low field strength in the buffer 670 is only an example, and data may be stored by classifying into two levels or four or more levels. For example, by applying not only an SNR but also a CRC as pass criteria, data may be classified and stored as high, mid, and low field strength that passed a CRC, and a ultra-low field strength that did not pass a CRC.

For training the generative neural network (G) of the radio feature estimation unit to be applied to low field strength, only data {Latent^{high}, Feature^{high}} and {Latent^{low}, Feature^{low}} of R^{high} and R^{low} may be selected from all stored data.

Then, to train to map low field strength latent information to high field strength feature information, the feature information in {Latent^{low}, Feature^{low}} may be replaced and mapped to {Latent^{low}, Feature^{high}} to be stored. In an embodiment, for stored data corresponding to ultra-low field strength that did not pass CRC among low field strength stored data, the feature information in ultra-low field strength stored data {Latent^{ultra-low}, Feature^{ultra-low}} may be replaced and mapped to {Latent^{ultra-low}, Feature^{high}} to be stored. Accordingly, the generative neural network (G) of the second radio feature estimation unit 635 for low field strength may effectively learn the distribution of high field strength feature information. Further, the finally configured training dataset {Latent^{high}, Feature^{high}} and {Latent^{low}, Feature^{high}} (or {Latent^{ultra-low}, Feature^{high}}) may be used for on-site training described below.

In an embodiment, the latent extraction unit 620 and the first radio feature estimation unit 630 of FIG. 6 may correspond to pre-trained analytic neural networks (f, g) through training data secured in advance based on statistical models, etc.

On the other hand, the second radio feature estimation unit 635 may correspond to the generative neural network (G) that has performed on-site training based on on-site data collected at a cell site level as described above. The on-site training may include online training that physically trains at the site by including a training module in the base station or centralized unit (CU) within the base station, and offline training that updates the neural network by training outside the base station or CU, such as on a local computer or server based on on-site data when online training is not possible.

FIG. 7 illustrates an example of a structure of an on-site training unit in a framework of a cellular generative neural network according to an embodiment of the disclosure.

FIG. 7 is a view illustrating the structure of the on-site training unit 505 illustrated in FIG. 5A.

FIG. 7 illustrates the structure of a training unit that trains the generative neural network (G) corresponding to the second radio feature estimation unit 635 based on the data collected in the buffer as described with reference to FIG. 6.

The training method of the generative neural network (G) according to the disclosure is to make the distribution p_{\hat{x}}(\hat{x}) of estimated features \hat{x} follow the distribution pₓ(x) of collected real feature data x to generate samples.

In an embodiment, the True Label to be used for training the generative neural network (G) may be set as radio features collected by the data collection method described with reference to FIG. 6. In an embodiment, among the collected radio features, those with a predetermined level or higher of reliability (R) may be selected and the reliability (R) may be reflected in a loss function for training. Further, a learning rate may be set according to the reliability (R).

The disclosure provides on-site generative neural network training that reflects the distribution of data collected on-site, and as an embodiment of generative training, a method using a generative adversarial network (GAN) according to the disclosure is described below.

Referring to FIG. 7, an on-site training unit 780 may include a generative neural network (G) 737 to be trained and a discriminator neural network (D) 739. The generative neural network (G) 737 may include the generative neural network (G) corresponding to the second radio feature estimation unit 635.

In an embodiment, the discriminator neural network (D) 739 may operate as a binary classification neural network that receives feature information generated from the generative neural network (G) 737 and actual data as input, and discriminates whether the input is real or fake.

Referring to FIG. 7, during GAN training, loss generated by the discriminator neural network (D) 739 may be used for training the generative neural network (G) 737.

More specifically, if generative training is not used, an analytic loss function such as cross entropy, mean squared error (MSE), L1-norm, or L2-norm may be used for neural network training.

On the other hand, when using GAN training, a loss function calculated by the discriminator neural network (D) 739 may be used to update the generative neural network (G) 737 in addition to or replacing the analytic loss function. Here, the discriminator neural network (D) 739 may be trained to estimate a feature learned by the generative neural network (G) 737 as 0 (fake) and an actually collected feature as 1 (real). The generative neural network (G) 737 may be trained in a direction that causes the discriminator neural network (D) 739 to estimate the feature generated by the generative neural network (G) as 1 (real).

Hereinafter, FIG. 8 describes the detailed operation of the on-site training unit described with reference to FIG. 7.

FIG. 8 illustrates an example of a training operation in an on-site training unit in a framework of a cellular generative neural network according to an embodiment of the disclosure.

FIG. 8 is a view illustrating the training operation in the cellular generative neural network (CGN) illustrated in FIG. 5A, particularly in the on-site training unit 505.

FIG. 8 illustrates the operation of training the generative neural network (G) 737 described with reference to FIG. 7 using the discriminator neural network (D) 739, and a generative neural network (G) 837 and a discriminator neural network (D) 839 of FIG. 8 may correspond to the generative neural network (G) 737 and discriminator neural network (D) 739 of FIG. 7, respectively.

For example, in the case of generative training using both L1-norm and GAN losses, this may be represented as the following Equations 5 and 6.

Using the latent information (Z) and feature pairs stored in the buffer 670 described with reference to FIG. 6 as input and label of the training dataset, respectively, a Generator loss function L_{GEN} of the generative neural network (G) 837 and a Discriminator loss function L_{DISC} of the discriminator neural network (D) 839 may be defined as follows in Equations 5 and 6.

$${L}_{DISC} = CE ( D ( G ( latent ) , latent ) , 0 ) + CE ( D ( feature , latent ) , 1 ) \qquad [ Equation 5 ]$$

$${L}_{GEN} = {δ}_{G} \cdot CE ( D ( G ( latent ) , latent ) , 1 ) + {δ}_{l} \cdot \vert G ( latent ) - feature \vert \qquad [ Equation 6 ]$$

Here, CE(A,B)=−ΣA(x)log B(x) is the cross-entropy (CE) loss function, H is the L1-norm, and δ_{G} and δₜ are the weights of GAN loss and L1-norm loss, respectively.

In the disclosure, the weights δ_{G} and δₜ are optimized and set according to an SNR and/or various environments.

In other words, using Equation 5, the discriminator neural network (D) 839 may be trained to estimate the output of the generative neural network (G) 837 as 0 (fake) and the real feature as 1 (real).

Further, using Equation 6, the generative neural network (G) 837 may be trained to generate a realistic feature that the trained discriminator neural network (D) 839 would judge as the real feature for training dataset inputs.

When the reliability check unit (RC) is configured as a neural network, the RC may be trained together with or independently of the generative neural network (G) 837. In an embodiment, the output of the reliability check unit (RC) may be used as the final output, and training may be performed using the feature information stored in the on-site buffer as the True Label and setting the MSE between the two as the loss function.

FIG. 9 illustrates operations in a system for cellular generative neural network training and inference according to an embodiment of the disclosure.

FIG. 9 illustrates operations in a system when applying the cellular generative neural network described with reference to FIGS. 5 to 8 to 5G uplink.

Referring to FIG. 9, a modem, buffer, and training entity (e.g., NPU or CU) of a base station (BS) may perform data collection for generative neural network training, generative neural network training, and inference operations from uplink signals transmitted by UEs in a cell.

Referring to FIG. 9, before on-site data collection, the cellular generative neural network may operate as an analytic neural network. In an embodiment, the base station may extract latent information (Z) from a pre-trained analytic neural network (f) corresponding to the latent extraction unit for uplink signals received from the terminal, and output (estimate) radio feature information from the latent information (Z) in an analytic neural network (g) corresponding to a feature estimation unit (operation 900). Thereafter, as described with reference to FIG. 6, the reliability check unit (RC) may collect data by storing radio feature information with reliability values above a predetermined reliability in a buffer (operation 910). For detailed operations on data collection, refer to FIG. 6.

After data collection is performed, the training entity (e.g., NPU or CU) of the base station may train the generative neural network (G) corresponding to the feature estimation unit as described with reference to FIGS. 7 and 8 (operation 920). In an embodiment, when the base station determines that data collection has been sufficiently performed, the training entity (e.g., NPU or CU) of the base station may train the generative neural network (G) corresponding to the feature estimation unit as described with reference to FIGS. 7 and 8 (operation 920). In an embodiment, the case where data collection is determined to be sufficiently performed may include cases where data collection of a predefined number or more has been performed. In this case, if the data collection unit and training unit are physically separated within the base station, the data collection unit may transmit a training ready signal to the on-site training unit.

For detailed operations on training of the generative neural network (G), refer to FIGS. 7 and 8. In an embodiment, the training entity (e.g., NPU or CU) of the base station may perform on-site training until one or more conditions are satisfied, examples of which may include training for a preset number of epochs, Generator loss converging below a preset specific value, or Discriminator loss converging to a preset specific value.

After training is complete, the generative neural network (G) reflecting radio feature distribution (on-site) may be used for radio feature inference. In an embodiment, the training entity (e.g., NPU or CU) of the base station may transmit parameters (e.g., weights or neural network structure information) of the generative neural network (G) updated through training to the base station modem (or feature inference unit within the modem) (operation 925), which may be used to infer radio feature information for received signals (operation 930). In an embodiment, the base station modem may receive on-site trained parameters (e.g., weights or neural network structure information) and update parameters of the generative neural network (G).

In an embodiment, the reliability check unit (RC) of the base station modem may determine whether to use the inference result of the generative neural network (G) reflecting the radio feature distribution through the training procedure (e.g., reflecting on-site trained parameters) or the inference result of the pre-trained analytic neural network (g) at the receiver.

In an embodiment, the reliability check unit (RC) of the base station modem may use the inference result of the analytic neural network (g) or the inference result of the generative neural network (G) reflecting radio feature distribution according to the SNR of the received signal. In an embodiment, when the inference results of the analytic neural network (g) and the generative neural network (G) differ by more than a threshold in regions where an SNR is above a predetermined level, an out of distribution (OOD) determination may be made and the inference result of the analytic neural network (g) may be used. In another embodiment, the reliability check unit (RC) may be configured as an RC neural network that takes an SNR, inference results of the analytic neural network (g) and generative neural network (G), and latent information (Z) as inputs and outputs a final radio feature.

After the first on-site training is completed, the inference unit of the base station modem may transmit a weight update request to the training unit periodically or in an event-driven manner. In the training unit, after receiving a weight update request signal from the inference unit or after a predetermined period set by the training unit has passed, after receiving a training ready signal that sufficient training data has been collected in the buffer, on-site training may be performed as described above and the weights of the generative neural network (G) may be updated again.

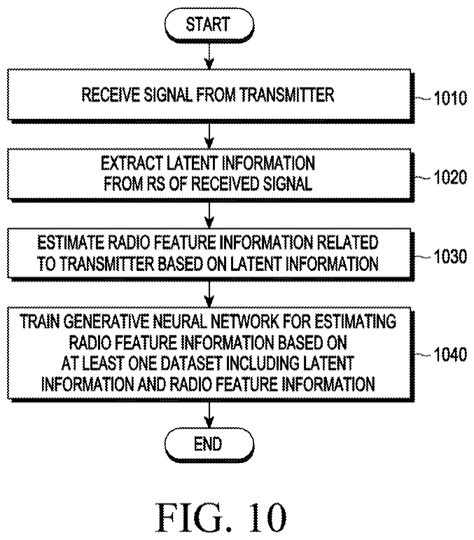

FIG. 10 is a flowchart illustrating an operation of an electronic device according to an embodiment of the disclosure.

The electronic device of FIG. 10 may correspond to a receiver according to an embodiment of the disclosure.

Referring to FIG. 10, in 1010, the receiver may receive a first signal from a transmitter.

In 1020, the receiver may extract latent information from a reference signal (RS) of the received first signal.

In 1030, the receiver may estimate radio feature information related to the transmitter based on the latent information.

In 1040, the receiver may train a generative neural network for estimating radio feature information based on at least one dataset including the latent information and the estimated radio feature information.

In an embodiment, the receiver may extract the latent information using a first analytic neural network. In an embodiment, the receiver may estimate the radio feature information related to the transmitter based on the latent information using at least one of a second analytic neural network and the generative neural network.

In an embodiment, the receiver may receive a second signal from the transmitter. In an embodiment, the receiver may extract second latent information from a RS of the second signal using the first analytic neural network. In an embodiment, the receiver may estimate second radio feature information based on the second latent information using at least one of the second analytic neural network and the trained generative neural network.

In an embodiment, the receiver may calculate a difference value between inference results of the second analytic neural network and the generative neural network. In an embodiment, when the difference value exceeds a predefined threshold, radio feature information may be estimated using the second analytic neural network.

In an embodiment, the receiver may identify at least one reliability of the at least one dataset based on at least one of a signal-to-noise ratio (SNR) and a cyclic redundancy check (CRC) of the received first signal.

In an embodiment, the at least one dataset may be stored in a buffer based on the at least one reliability. In an embodiment, the generative neural network may be trained based on the at least one dataset stored in the buffer.

In an embodiment, the receiver may store a dataset including latent information of a third signal, received from the transmitter, for which a CRC has failed and estimated radio feature information of a fourth signal, received from the transmitter, for which a CRC has passed.

In an embodiment, the receiver may train the generative neural network using a discriminator neural network for radio feature information included in the at least one dataset.

In an embodiment, the receiver may preprocess the RS. In an embodiment, the receiver may extract latent information from the preprocessed RS. In an embodiment, the radio feature information may include at least one of a channel feature, an interference feature, and a cell feature related to the transmitter. In an embodiment, the channel feature may include at least one of Doppler Spread, Doppler Shift, Delay Spread of Fading Channel, line of sight (LOS), and non-line of sight (NLOS). In an embodiment, the interference feature may include interference intensity per resource block (RB) or interference intensity per receiving antenna. In an embodiment, the cell feature may include beamforming-related information. In an embodiment, the generative neural network may include a generative adversarial network (GAN).

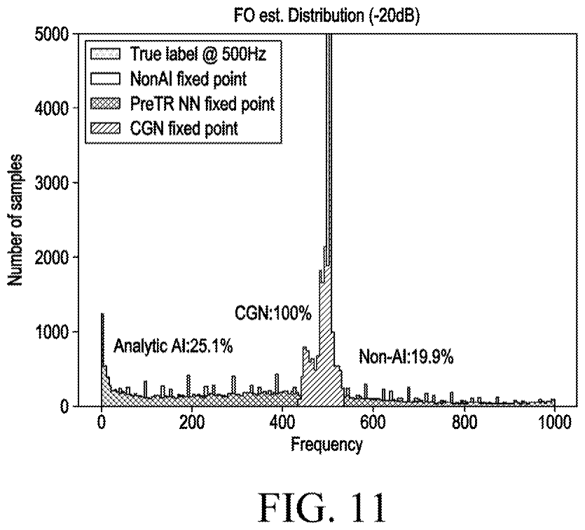

FIG. 11 illustrates results of estimating radio feature information (Doppler Shift) using a generative neural network according to an embodiment of the disclosure.

FIG. 11 illustrates a comparison of estimation performance of the cellular generative neural network (CGN) according to the disclosure, an analytic AI model, and a Non-AI model for Doppler Shift (e.g., frequency offset) in an ultra-low field strength of SNR=−20 dB.

Referring to FIG. 11, experimental results show that the cellular generative neural network (CGN) according to the disclosure achieves 100% performance, the analytic AI model achieves 25.1%, and the Non-AI model achieves 19.9%, demonstrating that the cellular generative neural network (CGN) with on-site training may perform highly reliable estimation even in ultra-low field strength.

Therefore, the disclosure may enhance channel estimation performance using a generative neural network that estimates a wireless channel, which is one of the radio features, by applying frequency domain filters with increased estimation reliability in urban/suburban circumstances, and applying time domain filters with increased Doppler estimation reliability in high-speed/low-speed environments.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. In one or more examples, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the components, elements, modules, units, or the like (collectively “components” in this paragraph) represented by a block or an equivalent indication (collectively “block”) in the above embodiments including the drawings, may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories to perform the functions or operations described herein.

These components may, for example, be embodied in one or more semiconductor chips, or on substrate supports such as printed circuit boards and the like. These circuits may also be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

The disclosure may efficiently learn and infer various feature information (e.g., channel features, signal interference features, etc.) for use in wireless communication systems based on a generative neural network, thereby contributing to enhanced adaptability to communication environment changes and communication quality.

The effects obtainable in the disclosure are not limited to the above-mentioned effects, and other effects not mentioned are clearly understood by those skilled in the art to which the disclosure pertains from the description above.

While the disclosure has been described with reference to example embodiments thereof, it will be apparent to those of ordinary skill in the art that various changes and modifications may be made thereto without departing from the spirit and scope of the disclosure as set forth in the following claims and their equivalents.

What is claimed is:

1. A receiver in a wireless communication system, comprising:
communication circuitry;
one or more processors communicatively connected to the communication circuitry; and
memory storing at least one instruction that, when executed by the one or more processors individually or collectively, causes the receiver to:
extract latent information from a reference signal (RS) of a first signal received from a transmitter via the communication circuitry;
based on the latent information, estimate radio feature information related to the transmitter; and
based on at least one dataset comprising the latent information and the estimated radio feature information, train a generative neural network for estimating radio feature information.

2. The receiver of claim 1, wherein the at least one instruction, when executed by the one or more processors individually or collectively, causes the receiver to:
extract the latent information using a first analytic neural network; and
estimate the radio feature information related to the transmitter based on the latent information using at least one of a second analytic neural network and the generative neural network.

3. The receiver of claim 2, wherein the at least one instruction, when executed by the one or more processors individually or collectively, causes the receiver to:
extract second latent information from a RS of a second signal, received from the transmitter, using the first analytic neural network, and
based on the second latent information, estimate second radio feature information using at least one of the second analytic neural network and the trained generative neural network.

4. The receiver of claim 3, wherein the at least one instruction, when executed by the one or more processors individually or collectively, causes the receiver to:
obtain a difference value between inference results of the second analytic neural network and the generative neural network; and
based on the difference value exceeding a predefined threshold, estimate the second radio feature information using the second analytic neural network.

5. The receiver of claim 1, wherein the at least one instruction, when executed by the one or more processors individually or collectively, causes the receiver to:
identify at least one reliability of the at least one dataset based on at least one of a signal-to-noise ratio (SNR) and a cyclic redundancy check (CRC) of the first signal; and
store the at least one dataset in a buffer based on the at least one reliability,
wherein the generative neural network is trained based on the at least one dataset stored in the buffer.

6. The receiver of claim 5, wherein the at least one instruction, when executed by the one or more processors individually or collectively, causes the receiver to:
store a dataset comprising latent information of a third signal, received from the transmitter, for which a CRC has failed, and estimated radio feature information of a fourth signal, received from the transmitter, for which a CRC has passed.

7. The receiver of claim 1, wherein the at least one instruction, when executed by the one or more processors individually or collectively, causes the receiver to train the generative neural network using a discriminator neural network for radio feature information included in the at least one dataset.

8. The receiver of claim 1, wherein the at least one instruction, when executed by the one or more processors individually or collectively, causes the receiver to:
preprocess the RS; and
extract latent information from the preprocessed RS.

9. The receiver of claim 1, wherein the radio feature information comprises at least one of a channel characteristic, an interference characteristic, and a cell characteristic related to the transmitter,
wherein the channel characteristic comprises at least one of Doppler spread, Doppler shift, delay spread of a fading channel, line of sight (LOS), or non-line of sight (NLOS),
wherein the interference characteristic comprises at least one of interference intensity per resource block (RB) or interference intensity per receiving antenna, and
wherein the cell characteristic comprise information related to beamforming.

10. The receiver of claim 1, wherein the generative neural network comprises a generative adversarial network (GAN).

11. A non-transitory computer-readable storage medium storing at least one instruction that, when executed by at least a portion of at least one processor of a receiver, causes the receiver to perform:
extracting latent information from a reference signal (RS) of a first signal received from a transmitter;
estimating radio feature information related to the transmitter based on the latent information; and
training a generative neural network for estimating radio feature information based on at least one dataset comprising the latent information and the estimated radio feature information.

12. The non-transitory computer-readable storage medium of claim 11, wherein the extracting comprises extracting the latent information using a first analytic neural network, and
wherein the estimating comprises estimating the radio feature information using at least one of a second analytic neural network and the generative neural network.

13. The non-transitory computer-readable storage medium of claim 12, wherein the at least one instruction further causes the receiver to perform:
extracting second latent information from a RS of a second signal, received from the transmitter, using the first analytic neural network; and
estimating second radio feature information based on the second latent information using at least one of the second analytic neural network and the trained generative neural network.

14. The non-transitory computer-readable storage medium of claim 13, wherein the estimating the second radio feature information comprises:
obtaining a difference value between inference results of the second analytic neural network and the generative neural network, and
based on the difference value exceeding a predefined threshold, estimating the second radio feature information using the second analytic neural network.

15. The non-transitory computer-readable storage medium of claim 11, wherein the at least one instruction further causes the receiver to perform:
identifying at least one reliability of the at least one dataset based on at least one of a signal-to-noise ratio (SNR) and a cyclic redundancy check (CRC) of the first signal; and
storing the at least one dataset in a buffer based on the at least one reliability, wherein the generative neural network is trained based on the at least one dataset stored in the buffer.

16. A method performed by a receiver in a wireless communication system, comprising:
extracting latent information from a reference signal (RS) of a first signal received from a transmitter;
estimating radio feature information related to the transmitter based on the latent information; and
training a generative neural network for estimating radio feature information based on at least one dataset comprising the latent information and the estimated radio feature information.

17. The method of claim 16, wherein the extracting comprises extracting the latent information using a first analytic neural network, and
wherein the estimating comprises estimating the radio feature information using at least one of a second analytic neural network and the generative neural network.

18. The method of claim 17, further comprising:
extracting second latent information from a RS of a second signal, received from the transmitter, using the first analytic neural network; and
estimating second radio feature information based on the second latent information using at least one of the second analytic neural network and the trained generative neural network.

19. The method of claim 18, wherein the estimating the second radio feature information comprises:
obtaining a difference value between inference results of the second analytic neural network and the generative neural network, and
based on the difference value exceeding a predefined threshold, estimating the second radio feature information using the second analytic neural network.

20. The method of claim 16, further comprising:
identifying at least one reliability of the at least one dataset based on at least one of a signal-to-noise ratio (SNR) and a cyclic redundancy check (CRC) of the first signal; and
storing the at least one dataset in a buffer based on the at least one reliability,
wherein the generative neural network is trained based on the at least one dataset stored in the buffer.
